(19) United States
(12) Patent Application Publication
(10) Pub. No.: US 2025/0271356 A1
(43) Pub. Date: Aug. 28, 2025

(54) METHOD AND APPARATUS FOR MEASURING A CONCENTRATION OF A GAS SPECIES

(71) Applicant: WILCO AG, Wohlen (CH)

(72) Inventors: Matthias KAHL, Lörrach (DE); Christoph HERDLITSCHKA, Zürich (CH)

(73) Assignee: WILCO AG, Wohlen (CH)

(21) Appl. No.: 19/103,863

(22) PCT Filed: Aug. 8, 2023
(86) PCT No.: PCT/EP2023/071981

§ 371 Date: Feb. 14, 2025

(30) Foreign Application Priority Data
Aug. 18, 2022 (CH) 000977/2022

(51) Int. Cl. G01N 21/3504; G01N 21/359; G01N 21/90; G01N 33/00

(52) U.S. Cl. CPC G01N 21/3504; G01N 21/359; G01N 21/90; G01N 33/004

(57) ABSTRACT

Method of determining a concentration of a first gas species in an interior space (3′) of a container (3), wherein the method comprises the steps:—transmitting first electromagnetic radiation of a first wavelength along a first radiation path (1) across said container, wherein said first wavelength corresponds to the wavelength of an absorption line of said first gas species;—transmitting second electromagnetic radiation of a second wavelength along a second radiation path (2) across said container, wherein said second wavelength corresponds to the wavelength of an absorption line of a second gas species, wherein said second radiation path is collinear with said first radiation path in a section (4) of said first radiation path and wherein said section extends at least across said interior space of said container;—receiving transmitted first electromagnetic radiation and determining a first characteristics of the received first electromagnetic radiation;—receiving transmitted second electromagnetic radiation and determining a second characteristics of the received second electromagnetic radiation;—determining said concentration of said first gas species in function of said first characteristics and of said second characteristics. Furthermore, the invention refers to an apparatus for determining a concentration of a gas species and to a use of the method.

The invention addressed herein relates to a method of determining a concentration of a gas species in an interior space of a container. Under further aspects, the invention relates to an apparatus for determining a concentration of a gas species and to a use of the method.

In various applications there are specific requirements to the composition of a gas present in a container with sensitive contents, such as medicals or food. Such contents for example need to be packed under very low oxygen concentration in order to prevent oxidization of the content, which would lead to a degradation of the content or a reduced lifetime of the content. There is need to verify that the oxygen concentration is low and stays low. For process control and quality control there is a need to determine a concentration of a gas species, as e.g., a concentration of oxygen, in a container.

As an example, infrared absorption spectroscopy is a known method, which is suitable to determine the concentration of specific monitored gases species in a container. This method allows to determine a concentration of a gas species in a container in a non-invasive and non-destructive way, i.e., without the need of entering with a part of the measuring apparatus into the container and the container, which may be filled with a precious content, can be further stored and used after the measurement. I.e., infrared absorption spectroscopy provides a non-destructive analysis method for the contents of a container. It is only infrared radiation that passes through the walls of the container and through the gas in the interior space of a container to be analyzed. The radiation intensity of the infrared radiation is reduced in absorption bands specific for different species of gas.

Interpreting the reduction of intensity in order to gain accurate information on the concentration of the gas species is hindered by various side effects. The dimensions and the form of an absorption band may not only depend on the concentration of the gas species, to which the absorption band belongs, but may also depend on total pressure in the container. Background effects may also originate from substances outside the container, such as thin water films, and are difficult to remove.

The object of the present invention is to provide a method or an apparatus, which overcomes at least a problem of the state of the art. In particular, an object of the invention is to increase the accuracy in determining a concentration of a gas species under varying conditions of total pressure.

This object is achieved by a method according to claim 1.

The method according to the invention is a method of determining a concentration of a first gas species in an interior space of a container. The method comprises the steps
transmitting first electromagnetic radiation of a first wavelength along a first radiation path across the container, wherein the first wavelength corresponds to the wavelength of an absorption line of the first gas species;
transmitting second electromagnetic radiation of a second wavelength along a second radiation path across the container, wherein the second wavelength corresponds to the wavelength of an absorption line of a second gas species, wherein the second radiation path is collinear with the first radiation path in a section of the first radiation path and wherein the section extends at least across the interior space of the container;
receiving transmitted first electromagnetic radiation and determining a first characteristic of the received first electromagnetic radiation;
receiving transmitted second electromagnetic radiation and determining a second characteristic of the received second electromagnetic radiation;
determining the concentration of the first gas species in function of the first characteristics and of the second characteristics.

According to the invention, the role of the second gas species is to provide an information, which is then used in determining the concentration of the first gas species. In addition to that, also the concentration of the second gas species may be determined. Furthermore, it is conceivable that the role of first and second gas species are reversed in a further step, such that both concentrations can be measured with high accuracy.

The container may contain a liquid or solid material and the gas concentration may be measured in the headspace above the liquid or solid material. The wall of the container, or at least a section of the wall, is of course made from a material that is at least partly transparent for electromagnetic radiation of the first and second wavelength.

Variants of the method result from the features as defined in the dependent claims 2 to 10.

In one variant of the method according to the invention, the transmitting first electromagnetic radiation and/or the transmitting second electromagnetic radiation is performed by an electromagnetic radiation source, in particular a laser, with a tunable emission frequency. The emission frequency is periodically swept over a spectral range covering the absorption line of the first gas species or over a spectral range covering the absorption line of the second gas species, respectively. The radiation source has a spectral bandwidth narrower than the spectral range.

This way, the form of the absorption band can be sampled over time. This form may be directly interpreted, or it may undergo a Fourier analysis. In the former case, e.g., a peak height or a width at a defined fraction of the peak height, e.g. at half the peak height, may be determined as first or second characteristics of the received radiation.

In the latter case, peak heights of a main peak and relative peak heights of sidebands may be determined as characteristic of the received radiation, e.g., a ratio of a first or second order sideband with respect to the main peak.

More specifically, a method known under the name Tunable Diode Laser Absorption Spectroscopy (abbreviated as TDLAS) may be applied. According to this method, the emission wavelength of a diode laser is tuned in a time-dependent way such that it scans over the wavelength region of the absorption line to be detected. The bandwidth of the laser line is much narrower than the absorption line, such that the wavelength dependency of the absorption line can be scanned. Typically, such a wavelength sweep occurs at a repetition rate of the order 1 kHz, and in form of a saw tooth shaped modulation. Superposed to this wavelength sweep, a higher frequency sine shaped modulation with a significantly smaller amplitude may be superposed. In this case, it is not the linear signal, i.e., the direct value of the transmission, which is evaluated. The reason for this is that a small variation on a large signal is difficult to detect. When analyzing the frequency composition of the signal after the passage through the container, the superposed frequency f and multiples thereof (2f, 3f, . . . ) can be found. This may be realized in so-called lock-in technique, e.g., as specifically adapted electronics circuit. The signal strength found at frequency f corresponds to the first derivative of the absorption line, the signal strength found at 2f corresponds to the second derivative of the absorption line, etc.

Further properties of the transmission line may be analyzed, such as for example peak height, peak width, area under the peak. A similar analysis may be applied to the first derivative, the second derivative, and so on.

In a variant of the method involving a transmission source with a tunable emission frequency, both transmission sources have this property. In this variant, the first electromagnetic radiation source is an electromagnetic radiation sources with a first tunable emission frequency. The second electromagnetic radiation source is an electromagnetic radiation sources with a second tunable emission frequency. The first tunable emission frequency is periodically swept over a spectral range covering the absorption line of the first gas species with a first repetition rate. The second tunable emission frequency is periodically swept over a spectral range covering the absorption line of the second gas species with a second repetition rate.

Thereby, the second repetition rate differs from the first repetition rate by at least 0.01% of the first repetition rate.

The inventors have recognized that surprisingly, although first and second emission frequencies differ from each other, unwanted beat frequencies may occur in the measurements, if the two repetition rates are too close to each other.

As an example, numerical values are given to illustrate an acceptable solution. Both transmission sources may be tunable diode lasers operated with a control board having an 8 MHz internal clock. A repetition rate in the order of 1 kHz may be used. A complete wavelength sweep of the first tunable emission frequency may then be performed in 8000 clock cycles. To achieve a second repetition rate which differs enough from the first repetition rate, a complete wavelength sweep of the second tunable emission frequency may be performed in 7999 or 8001 clock cycles, thus leading to a relative difference of 1/8000=0.0125% from the first repetition rate. However, as recognized by the inventors, selecting the identical number of 8000 clock cycles may lead to beating effects, due to the slight differences in the two oscillators defining the clock of the two control boards involved.

In one variant of the method according to the invention, the first and the second gas species are selected from the list of:
oxygen,
water vapor,
carbon dioxide.

These gas species provide important information regarding the gas contents of the container and regarding the condition of product packaged in the container. All gas species of the list have absorption bands in the infrared wavelength range, in particular in the near infrared range between 700 nanometer and 1.4 micrometer wavelength, which is well suited to perform the method according to the invention. The selection of the gas species according to this variant has the following advantages. Oxygen is always present in air. Humidity, i.e., residuals of water leading to water vapor in the head space of a container, is often present even in surroundings deliberately produced to be oxygen-free. Consumption of oxygen and production of carbon dioxide and water relates to most biological activities.

In one variant of the method according to the invention, the first characteristic is a peak height of an absorption line of the first gas species and the second characteristic is a width of an absorption line of the second gas species. A total pressure inside the container is determined based on the width. The concentration is finally determined as a function of the peak height and the total pressure.

This variant of the method is useful, if the form of the absorption band of the first gas species strongly depends on the total pressure of the gas. The linewidth of some gas species, such as water vapor, is a good indicator of the total pressure of the gas. With the knowledge of the total pressure, the characteristics of the received first electromagnetic radiation then can correctly interpreted to derive the concentration of the first gas species with high accuracy.

In one variant of the method according to the invention, the first gas species is oxygen and wherein the second gas species is water vapor.

According to this variant, the total pressure in the container is derived from the width of an absorption line of water vapor. With the knowledge of the total pressure, the peak height of the oxygen absorption line can be interpreted, such that an accurate value of the oxygen concentration results.

The absorption line of water vapor (e.g., at 1380 nm wavelength) has the property that it hardly changes its peak height depending on the water concentration. Its linewidth increases approximately proportional to the total pressure.

The absorption line of oxygen (e.g., at 760 nm wavelength) has a peak height, which increases approximately proportional to the concentration of oxygen, if the total pressure below approximately 700 mbar. Above approximately 700 mbar, the peak height of the oxygen absorption line does not change significantly anymore, neither in peak height nor in peak width. However, above 700 mbar the peak width of the H₂O line continues to change with increasing total pressure. From the combination of both characteristics, a partial pressure of oxygen can be derived over a larger range of total pressure, including total pressure above atmospheric pressure.

This variant of the method may be used in the context of a leak test for containers, which need to be sealed in a gas tight manner. The containers are sealed in under-pressure environment. If the oxygen concentration inside the container increases over time, this indicates that surrounding air is entering the container. A comparison of measurements of oxygen concentration directly after closing the container and e.g., two or three weeks later gives a sensitive indicator even for the presence of small leaks.

In one variant of the method according to the invention, the first gas species is oxygen and wherein the second gas species is carbon dioxide.

This combination of first and second gas species is particularly useful to assess the sterility of a sample.

In one variant of the method according to the invention, wherein in addition to a concentration of oxygen as the first gas species, also a concentration of carbon dioxide is determined.

From the combination of both concentrations, the presence of biological activity can be detected or excluded. Nearly any biological activity affects the ratio of oxygen concentration versus carbon dioxide concentration. Bacteria and fungi consume oxygen and produce carbon dioxide, which results in measurable changes of the respective gas concentrations over time.

In one variant of the method according to the invention, the first gas species is water vapor and wherein the second gas species is carbon dioxide.

The inventors have recognized that the measurement of a concentration of water vapor benefits from a knowledge of a concentration of carbon dioxide, which is a molecule with three atoms, as water, but has different properties regarding adhesion on surfaces or penetration into media.

In one variant of the method according to the invention, the method comprises a calibration procedure and a measuring procedure. The calibration procedure performs all the steps of the inventive method with a first container containing a known concentration of a second gas species. The measuring procedure performs all the steps of the inventive method with a second container. A background contribution of a first gas species is determined based on the calibration procedure. A provisional concentration of the first gas species in the second container is determined based on the measuring procedure. The background contribution is subtracted from the provisional concentration of the first gas species in order to determine the concentration of the first gas species in the second container. The first and the second gas species are different gas species.

In the following, a specific variant is discussed, in which variant the first gas species is water vapor and wherein the second gas species is carbon dioxide, the method comprising a calibration procedure and a measuring procedure. The calibration procedure performs all the steps of the inventive method with a first container containing a known concentration of carbon dioxide. The measuring procedure performs all the steps of the inventive method with a second container. A background contribution of water is determined based on the calibration procedure. A provisional concentration of water vapor in the second container is determined based on the measuring procedure. The background contribution is subtracted from the provisional concentration of water vapor in order to determine the concentration of water vapor in the second container.

The first container has the role of a standard or calibration container, whereas the second container has the role of the unit under test.

Measuring humidity in a container, which is among other factors defined by the concentration of water vapor, generally is difficult, as different to other gases, water is difficult to replace it completely by a flushing gas, such as nitrogen. Even if inside a measuring apparatus a defined gas composition, preferably with very low water vapor concentration, is present, there may still be residual humidity on windows of the apparatus or on a surface of the container to be tested. If harsh measures, such as heating to high temperatures, must be avoided due to the delicate contents of the container. A requirement may be that at least all the humidity is in the gas phase, which may only be achieved by applying harsh measures. A container with unknown water content and unknown total pressure is hard to measure. On the other hand, it is difficult to produce a defined humidity standard, as water is easily adsorbed, it may enter deeply into various media and humidity is temperature dependent.

The inventors have recognized that both problems may be avoided by proceeding according the above-discussed variant of the method. For this purpose, only a reference container with accurately defined carbon dioxide concentration needs to be provided, which is much easier to realize than a humidity standard of a corresponding accuracy.

The discussed variant of the method may be further extended to a recurring method, by using a value determined for a first gas species to improve a result for a second gas species, then using the improved result from the second gas species to improve the value for the first gas species again, and so on.

Variants of the method may be combined with one or more of the other variants unless in contradiction.

Further in the scope of the invention lies an apparatus according to claim 11.

The inventive apparatus is an apparatus for determining a concentration of a first gas species. The apparatus comprises
a first transmitter adapted to transmit first electromagnetic radiation of a first wavelength, wherein the first wavelength corresponds to the wavelength of an absorption line of the first gas species;
a second transmitter of second electromagnetic radiation of a second wavelength, wherein the second wavelength corresponds to the wavelength of an absorption line of a second gas species;
a first receiver for electromagnetic radiation;
a second receiver for electromagnetic radiation;
   wherein the apparatus defines a space adapted to receive a container;
   wherein the apparatus is configured to transmit the first electromagnetic along a first radiation path across the space and to the first receiver,
   wherein the apparatus is configured to transmit the second electromagnetic radiation along a second radiation path across the space and to the second receiver,
   wherein the first radiation path and the second radiation path are collinear in a section of the first radiation path, and wherein the section extends at least across the space.

The first and second receivers may have filters in front of a radiation sensitive part, which filter lets only pass wavelength close to said first wavelength or said second wavelength, respectively. At the receiver's side of the section, in which the radiation paths are collinear, this section may be delimited by a prism or an optical grid, which imposes different directions on radiation of different wavelength. Alternatively, a dichroic beam splitter may be configured to reflect electromagnetic radiation of the first wavelength and to let pass electromagnetic radiation of the second wavelength. In this alternative, the section, in which the radiation paths are collinear, ends at the point where the radiation paths hit the beam splitter.

Embodiments of the apparatus according to the invention result from the features as defined in claims 11 to 14.

In one embodiment of the apparatus according to the invention, the section is delimited by at least one dichroic beam splitter. The section may be delimited by dichroic beam splitters on both ends of the section or on one end of the section. In particular, on the transmitter side of the section, a dichroic beam splitter may be arranged to bring two radiation paths with originally different direction together on a common collinear section.

In one embodiment of the apparatus according to the invention, the first transmitter, the second transmitter, the first receiver and the second receiver are encapsulated in an interior of a housing having a window, wherein the space is located in an exterior of the housing and wherein the first and the second radiation path cross the window.

The embodiment may be realized with a single window and a reflector element for the electromagnetic radiation, such as a mirror, outside the housing. First and second radiation path may run twice across the space for receiving a container, a first time after exiting through the window and before being reflected and a second time after being reflected and before reentering through the window into the housing. In an alternative, there is a second window in the housing. The second window is arranged opposite to the first window with respect to the space for receiving a container. The first and second radiation paths exit through one window from the housing and enter through the other window into the housing in this alternative. The housing including the window or the windows, respectively, may be gas tight and the interior of the housing may be filled with a gas composition, which is adapted to the gas concentrations to be measured. In particular, the concentrations of the first and second gas species may be at least an order of magnitude lower than the concentrations to be determined. The housing may contain desiccator material in order to keep humidity low in the interior of the housing. This is particularly useful, if the first or second gas species is water vapor. The gas composition may be free of molecular oxygen. The gas composition inside the housing may e.g., be nitrogen. This embodiment may be combined with the embodiment comprising dichroic beam splitters. In this combination, the dichroic beam splitters may be arranged in the interior of the housing.

In one embodiment of the apparatus according to the invention, the apparatus is adapted and configured to perform the method according to the invention.

Embodiments of the apparatus may be combined with one or more of the other embodiments or may specifically be adapted and configured to perform a variant of the method, unless in contradiction.

In particular, the apparatus may comprise means for determining the first and second characteristics and for determining the concentration of the first gas species. Such means may e.g., be realized as a microprocessor. As an alternative, the apparatus may be operationally connected to such means, e.g., be connected to a desktop computer or a server. The operational connection may be established via a wire-bound or a wire-less network. The apparatus may comprise means for displaying the concentration of the gas species or means for storing the determined concentrations, e.g., together with an identifier identifying an individual container.

The invention is further directed to a use according to claim 15.

It is a use for the detection of microbial growth, in particular in the context of a media fill test. It makes use of the variant of the method, wherein in addition to a concentration of oxygen, also a concentration of carbon dioxide is determined.

In the field of aseptic production and packaging of pharmaceutical products, product quality can often not be assured by applying final test. Safety of the product and the packaging process is assured by a validation process, in which nutrient media are packaged, so called media fills. The inventors have recognized that the method according to the invention allows to monitor the oxygen and carbon dioxide concentration in individual containers of a large set of containers over time and with high accuracy.

The presence of microbiological activity can be detected or excluded for each individual container.

The invention shall now be further exemplified with the help of figures. The figures show:

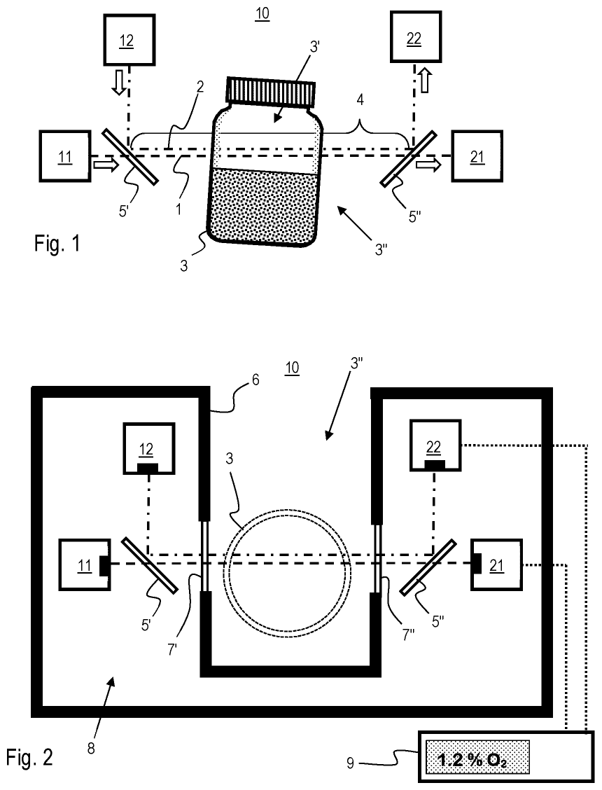

FIG. 1 a schematic and illustrative view of the situation around a container, which undergoes the steps of the method according to the invention;

FIG. 2 a cross-section through an embodiment of the apparatus according to the invention.

FIG. 1 shows schematically and simplified, a container 3 undergoing a determination of a gas species in an interior space 3′. First electromagnetic radiation follows a first radiation path 1 shown as dashed line. Second electromagnetic radiation follows a second radiation path shown as dash-dotted line. The direction of the radiation is indicated by arrows. The first and second electromagnetic radiation are transmitted from first (11) and second (12) transmitters, pass across the interior space 3′ of the container 3 and are received by first (21) or second (22) receivers, respectively. The first radiation path 1 and the second radiation path 2 are collinear in a section 4 of said first radiation path. This section 4 extends across the interior space 3′ of the container. In the situation shown here, the common section of both radiation paths is delimited by dichroic beam splitters 5′, 5′'. The beam splitters let transmit the first wavelength of the first electromagnetic radiation and reflect the second wavelength of the second electromagnetic radiation. In the embodiment shown here, the first radiation path follows a straight line from the first transmitter to the first receiver. Due to the dichroic beam splitters, which are oriented at a 45-degree angle with respect to the first radiation path, the second radiation path hits on an 90 degree angle with respect to the first radiation path onto the dichroic beam splitter 5′ and subsequently runs collinear with the first radiation path. After passing the interior space of the container, in this case the headspace above some material packaged in the container, the two radiation paths are separated again by a beam splitter 5″, before they are received by corresponding first 21 and second 22 receivers.

As is indicated by the slightly tilted container, the relative orientation of the container may vary—be it by deliberately tilting the container, in order to avoid interference effects from partial reflections on the container walls, or be it due to mechanical tolerances. With the method according to the invention, the path length of both radiation paths in the interior space of the container is identical. This helps in the comparison and interpretation of the characteristics derived from the first and second radiation received. If for example the path length of the first electromagnetic radiation inside the container becomes longer than the diameter of the container due to tilting, the path length of the second electromagnetic radiation inside the container increases by the same amount.

FIG. 2 shows a cross-section through an embodiment of the apparatus 10. It has first 11 and second 12 transmitters, first 21 and second 22 receivers and beam splitters 5′ and 5″, which define a first radiation path 1 and a second radiation path 2, as discussed in the context of FIG. 1. Also here, the first radiation path 1 and the second radiation path 2 are collinear in a common section. The apparatus defines a space 3″ for receiving a container. The discussed section of the first radiation path runs across the space 3″, which space in this embodiment is delimited among others, by the windows 7′ and 7″. The section is delimited by dichroic beam splitters 5′ and 5″ . A possible position of a cylindrical container 3 shown in top view is indicated by dashed circles. A housing 6, including the windows 7′, 7″, enclose an interior 8 of the apparatus in a gas tight way. As symbolized by dotted lines, the receivers 21, 22 are operationally connected to means 9 for determining the concentration of at least the first gas species in the interior of the container. In this case, this means 9 are furthermore adapted to display the concentration of the first gas species.

The windows 7′, 7″ preferably are highly transmissive at the first and the second wavelength of the electromagnetic radiation. The dichroic beamsplitters 5′, 5″ are transmissive at the first wavelength and are mostly reflective at the second wavelength.

The region 3″ surrounding the container may be flushed by a gas of defined composition, in particular by a gas being free of the gas species to be measured. E.g., the surrounding may be flushed by nitrogen, if gas species of interest are in the group comprising oxygen, water vapor and carbon dioxide.

As a variant not shown in the figure, the walls of the apparatus may be arranged such that they surround the region, where the measurement occurs. In such variants, a container to be measured may enter the apparatus through a lock chamber

### LIST OF REFERENCE SIGNS

1 first radiation path
2 second radiation path
3 container
3′ interior space (of the container)
3″ space for receiving a container
4 section (of first radiation path)
5′ dichroic beam splitter
5″ dichroic beam splitter
6 housing
7′ (first) window
7″ (second) window
8 interior space (of the housing)
9 means for determining/displaying the concentration
10 apparatus
11 first transmitter
12 second transmitter
21 first receiver
22 second receiver

1. A method of determining a concentration of a first gas species in an interior space of a container, wherein the method comprises the steps
transmitting first electromagnetic radiation of a first wavelength along a first radiation path across the said container, wherein the first wavelength corresponds to the wavelength of an absorption line of the first gas species;
transmitting second electromagnetic radiation of a second wavelength along a second radiation path across the container, wherein the second wavelength corresponds to the wavelength of an absorption line of a second gas species, wherein the second radiation path is collinear with the first radiation path in a section of the first radiation path and wherein the section extends at least across the interior space of the container;
receiving transmitted first electromagnetic radiation and determining a first characteristic of the received first electromagnetic radiation;
receiving transmitted second electromagnetic radiation and determining a second characteristic of the received second electromagnetic radiation;
determining the concentration of the first gas species in function of the first characteristics and of the second characteristics.

2. The method according to claim 1, wherein the transmitting first electromagnetic radiation and/or the transmitting second electromagnetic radiation is performed by an electromagnetic radiation source, with a tunable emission frequency and wherein the emission frequency is periodically swept over a spectral range covering the absorption line of the first gas species or over a spectral range covering the absorption line of the second gas species, respectively, wherein the radiation source has a spectral bandwidth narrower than the spectral range.

3. The method according to claim 2, wherein the first electromagnetic radiation source is an electromagnetic radiation sources with a first tunable emission frequency and the second electromagnetic radiation source is an electromagnetic radiation sources with a second tunable emission frequency, wherein the first tunable emission frequency is periodically swept over a spectral range covering the absorption line of the first gas species with a first repetition rate, wherein the second tunable emission frequency is periodically swept over a spectral range covering the absorption line of the second gas species with a second repetition rate, and wherein the second repetition rate differs from the first repletion rate by at least 0.01% of the first repetition rate.

4. The method according to claim 1, wherein the first and the second gas species are selected from the list of:
oxygen,
water vapor,
carbon dioxide.

5. The method according to claim 1, wherein the first characteristic is a peak height of an absorption line of the first gas species, wherein the second characteristic is a width of an absorption line of the second gas species, wherein a total pressure inside the container is determined based on the width, and wherein the concentration is determined as a function of the peak height and the said total pressure.

6. The method according to claim 5, wherein the first gas species is oxygen and wherein the second gas species is water vapor.

7. The method according to claim 1, wherein the first gas species is oxygen and wherein the second gas species is carbon dioxide.

8. The method according to claim 7, wherein in addition to a concentration of oxygen, also a concentration of carbon dioxide is determined.

9. The method according to claim 1, wherein the first gas species is water vapor and wherein the second gas species is carbon dioxide.

10. The method according to claim 9, wherein the method comprises
a calibration procedure performing all the steps of method for determining the concentration of the first gas species in an interior space of the container, the method comprising:
transmitting the first electromagnetic radiation of the first wavelength along the first radiation path across the container;
transmitting the second electromagnetic radiation of the second wavelength along the second radiation path across the container;
receiving the transmitted first electromagnetic radiation and determining a first characteristic of the received first electromagnetic radiation;
receiving the transmitted second electromagnetic radiation and determining a second characteristic of the received second electromagnetic radiation; and
determining the concentration of the first gas species in function of the first characteristics and of the second characteristics with a first container containing a known concentration of a second gas species and
a measuring procedure performing all the steps of the method with a second container, wherein a background contribution of a first gas species is determined based on the calibration procedure, wherein a provisional concentration of the first gas species in the second container is determined based on the measuring procedure and wherein the background contribution is subtracted from the provisional concentration of the first gas species in order to determine the concentration of the first gas species in the second container.

11. An apparatus for determining a concentration of a first gas species, wherein the apparatus comprises
a first transmitter adapted to transmit first electromagnetic radiation of a first wavelength, wherein the first wavelength corresponds to the wavelength of an absorption line of the first gas species;
a second transmitter of second electromagnetic radiation of a second wavelength, wherein the second wavelength corresponds to the wavelength of an absorption line of a second gas species;
a first receiver for electromagnetic radiation;
a second receiver for electromagnetic radiation;
wherein the apparatus defines a adapted to receive a container;
wherein the apparatus is configured to transmit the first electromagnetic along a first radiation path across the space and to the first receiver,
wherein the apparatus is configured to transmit the second electromagnetic radiation along a second radiation path across the space and to the second receiver,
wherein the first radiation path and the second radiation path are collinear in a section of the first radiation path, and
wherein the section extends at least across the space.

12. The apparatus according to claim 11, wherein the section is delimited by at least one dichroic beam splitter.

13. The apparatus according to claim 11, wherein the first transmitter, the second transmitter, the first receiver and the second receiver are encapsulated in an interior of a housing having a window, wherein the space is located in an exterior of the housing and wherein the first and the second radiation path cross the window.

14. The apparatus according to claim 11, wherein the apparatus is adapted and configured to perform a method for determining the concentration of the first gas species in an interior space of the container, the method comprising:
transmitting the first electromagnetic radiation of the first wavelength along the first radiation path across the container;
transmitting the second electromagnetic radiation of the second wavelength along the second radiation path across the container;
receiving the transmitted first electromagnetic radiation and determining a first characteristic of the received first electromagnetic radiation;
receiving the transmitted second electromagnetic radiation and determining a second characteristic of the received second electromagnetic radiation; and
determining the concentration of the first gas species in function of the first characteristics and of the second characteristics.

15. A method for detecting microbial growth, the method comprising:
performing the method according to claim 1, wherein the first gas species is oxygen and the second gas species is carbon dioxide, and in addition to a concentration of oxygen, also a concentration of carbon dioxide is determined; and
detecting the presence or absence of microbiological activity based on the determined concentrations of oxygen and carbon dioxide.
